(19) United States
(12) Patent Application Publication
(10) Pub. No.: US 2001/0022792 A1
(43) Pub. Date: Sep. 20, 2001

(54) Data compression method, data retrieval method, data retrieval apparatus, recording medium, and data packet signal

(76) Inventors: Tamaki Maeno, Tokyo (JP); Akira Asano, Tokyo (JP)

Correspondence Address: Jay H. Maioli, COOPER & DUNHAM LLP, 1185 Avenue of the Americas, New York, NY, 10036, US

(21) Appl. No.: 09/766,919

(22) Filed: Jan. 22, 2001

(30) Foreign Application Priority Data
Jan. 25, 2000 (JP) P2000-015617
Jan. 10, 2001 (JP) P2001-002277

(51) Int. Cl. H04J 3/00

(52) U.S. Cl. 370/521

(57) ABSTRACT

A method of generating a data packet having main data and compressed search data for efficiently retrieving the main data, a retrieval method and a retrieval apparatus for efficiently retrieving the main data by a search key given by plural data packets, a recording medium in which these plural data packets are recorded, and a data packet signal having main data and compressed search data for efficiently retrieving the main data.

### BACKGROUND OF THE INVENTION

The present invention relates generally to a method of generating a data packet containing main data and retrieval data compressed for efficiently retrieve the main data. In addition, the present invention relates generally to a data retrieval method for efficiently retrieving, from plural data packets containing main data and retrieval data compressed for efficient retrieval of the main data, the main data on the basis of an inputted search key. Moreover, the present invention relates generally to a data retrieval apparatus for efficiently retrieving, from plural data packets containing main data and retrieval data compressed for efficient retrieval of the main data, the main data on the basis of an inputted search key. Further, the present invention relates generally to a recording medium which records plural data packets containing main data and retrieval data compressed for efficient retrieval of the main data. Still further, the present invention relates generally to a data packet signal containing main data and retrieval data compressed for efficient retrieval of the main data.

So-called database retrieval apparatuses and so-called electronic dictionary apparatuses are in wide use in which all or part of a character string of data to be retrieved is inputted, and retrieved data or texts are displayed. Like functionality is also implemented by electronic dictionary programs and database programs that operated on personal computers.

The following describes, with reference to FIG. 1, data retrieval processing in a related art database retrieval apparatus in which data for retrieval are recorded on an information recording medium such as a CD-ROM (compact Disc-Read Only Memory) or a semiconductor memory.

By use of an inputted character string corresponding to data to be retrieved as a search key, the database retrieval apparatus searches a text body database 12 recorded on an information storage medium beforehand for the data on the basis of an index 11 stored on an information storage medium. Then the database retrieval apparatus displays the retrieved data.

The index 11 is data for so-called forward matching search and consists of one index block 21 belonging to a primary index block layer, n index blocks 22-1 through 22-n belonging to a secondary index block layer, and m index blocks 23-1 through 23-m belonging to a tertiary index block layer.

The index 11 is configured in accordance with search methods such as forward matching search and backward matching search for example, each index being stored in an information storage medium beforehand. To be more specific, if the database retrieval apparatus can execute forward matching search or backward matching search for example, the information storage medium stores a forward matching search index and a backward matching search index.

The index block 21, the index blocks 22-1 through 22-n, and the index blocks 23-1 through 23-m each have compare keys such as “AP” and “BO” which are compared with the search key and the addresses corresponding to the compare keys or data addresses. The compare keys are arranged in the ascending order of alphabets.

Each address of the index block 21 indicates a head storage location of one of the index blocks 22-1 through 22-n belonging to the secondary index block layer. Each address of each of the index blocks 22-1 through 22-n indicates the head storage location of one of the index blocks 23-1 through 23-n belonging to the tertiary index block layer. Each text body address of each of the index blocks 23-1 through 23-m indicates the storage location of predetermined data stored in the text body database 12.

When a character string corresponding to data to be retrieved is inputted, the database retrieval apparatus, using the inputted character string as an search key, compares the first two characters of the search key with a compare key of the index block 21. On the basis of this comparison, the database retrieval apparatus determines whether these two characters are located in alphabetic order before or after the compare key of the index block 21 or the same as this compare key.

If the first two characters of the search key are found located in alphabetic order be hind the compare key of the index block 21, then the database retrieval apparatus compares the first two characters of the search key with a next compare key of the index block 21.

If the first two characters of the search key are found located in alphabetic order before the next compare key of the index block 21 or the same as this compare key, then the database retrieval apparatus, on the basis of the address corresponding to this compare key of the index block 21, specifies corresponding one of the index blocks 22-1 through 22-n belonging to the secondary index block layer.

Then, the database retrieval apparatus compares the first two characters of the search key with a compare key of the specified one of the index blocks 22-1 through 22-n to execute the same processing as with the index block 21. On the basis of this comparison, the database retrieval apparatus determines whether the first two characters of the search key are located in alphabetic order before or after the compare key of the specified one of the index blocks 22-1 through 22-n or the same as this compare key.

If the first two characters of the search key are found located in alphabetic order behind the compare key of the specified one of the index blocks 22-1 through 22n, the database retrieval apparatus compares the first two characters of the search key with a next key of the specified one of the index blocks 22-1 through 22-n.

If the first two characters of the search key are found located in alphabetic order before the next compare key of the specified one of the index blocks 22-1 through 22-n or the same as this compare key, then the database retrieval apparatus, on the basis of the address corresponding to the compare key of the specified one of the index blocks 22-1 through 22-n, specifies corresponding one of the index blocks 23-1 through 23-m belonging to the tertiary index block layer.

Then, the database retrieval apparatus compares all characters of the search key with a compare key of the specified one of the index blocks 23-1 through 23-m. On the basis of this comparison, the database retrieval apparatus determines whether the search key is located in alphabetic order behind the compare key of the specified one of the index blocks 23-1 through 23-m, is the same as the compare key, or is included in the compare key.

If the search key is found located in alphabetic order behind the compare key of the specified one of the index blocks 23-1 through 23-m, the database retrieval apparatus compares the search key with a next compare key of the specified one of the index blocks 23-1 through 23-m.

If the search key is found the same as the compare key or found included in the compare key, the database retrieval apparatus, on the basis of the address of the data corresponding to the compare key of the specified one of the index blocks 23-1 through 23-m, specifies a corresponding text body stored in the text body database 12.

To be more specific, if a character string “abroad” is inputted for the data to be retrieved, the search becomes “ABROAD” and the first two characters “AB” are compared with the compare keys of the index block 21, sequentially from top down as shown in FIG. 1. Because the first two characters “AB” of the search key are located in alphabetic order before the first compare key “AP” of the index block 21, the database retrieval apparatus, on the basis of the address corresponding to the compare key “AP”, specifies the index block 22-1 belonging to the secondary index block layer.

Because the first two characters “AB” of the search key are located in alphabetic order before the first compare key “AC” of the index block 22-1, the database retrieval apparatus, on the basis of the address corresponding to the compare key “AC”, specifies the index block 23-1 belonging to the tertiary index block layer.

The database retrieval apparatus detects the third compare key “ABROAD” from top in the index block 23-1 corresponding to the search key “ABROAD” and, on the basis of the address of the data corresponding to this compare key “ABROAD”, reads and displays the data from the text body database 12.

In other information storage media, no index is used. Namely, keywords are stored in correspondence with main data in the text body database in advance. The database retrieval apparatus retrieves the main data on the basis of the stored keywords.

Referring to FIG. 2, there is shown one example of a related-art text body database 31 in which a keyword is stored in advance in correspondence with the main data. The text body database 31 stores the main data in the ascending order of alphabets.

“TOP” in the text body database 31 indicates an identifier located before the header for the main data. “KW” of the text body database 31 indicates an identifier located before the keyword for the main data, and an identifier having value “00” is located after the keyword.

The main data are located after the identifier having value “00”.

Referring to FIG. 2, in data “TOP ap.ple KW APPLE 00 A kind of fruits”, “ap.ple” located between the first identifier “TOP” and the second identifier “KW” indicates a header. “APPLE” located between the second identifier “KW” and the third identifier “00” indicates the keyword for header “ap.ple”. “A kind of fruits” located behind the third identifier “00” indicates the main data for header “ap.ple” and keyword “APPLE”.

Likewise, in data “TOP Ap.ple seed KW APPLESEED 00 Johnny (John Chapman)” in the text body database 31, “Ap.ple seed” located between the identifier “TOP” and the identifier “KW” indicates a header. “APPLESEED” located between the identifier “KW” and the identifier “00” indicates the keyword for the header “Ap.ple.seed”. “Johnny (John Chapman)” located behind the identifier “00” indicates the main data for the header “Ap.ple. seed” and the keyword “APPLESEED”.

The following describes, with reference to the flowchart shown in FIG. 3, the processing of comparison between a search key and a selected keyword to be executed by the related-art database retrieval apparatus for retrieving the text body database 31. In step S11, the database retrieval apparatus reads the first character of the search key. In step S12, the database retrieval apparatus reads the first character of the selected keyword.

In step S13, the database retrieval apparatus determines whether there is a match between the first character of the search key and the first character of the selected keyword. If a match is found, then, in step S14, the database retrieval apparatus determines whether the first character of the search key and the first character of the selected keyword are their last characters or not.

If the decision is yes in step S14, then the database retrieval apparatus outputs a message indicative that the search key matches the selected keyword in step S15, upon which the processing comes to an end.

If the decision is no in step S13, then the database retrieval apparatus outputs a message indicative that the search key does not match the selected keyword in step S16, upon which the processing comes to an end.

If the decision is no in step S14, it means that there remain characters to be compared, so that, in step S17, the database retrieval apparatus reads a next character of the search key. In step S18, the database retrieval apparatus reads a next character of the keyword. Then, back in step S13, the database retrieval apparatus repeats the above-mentioned compare processing.

However, the data retrieval by use of indexes involves a problem that the indexes data of predetermined amounts must be stored in an information storage medium along with the main data, thus requiring the provision of an information storage medium having a proportionately large storage area. For example, the main data containing a text body of 60,000 to 70,000 words amounts to 30 megabytes while the indexes amount to about 8 megabytes.

The main data retrieval by use of keywords arranged in the main data, rather than using indexes, requires comparisons between many characters, taking long time for retrieval processing.

### SUMMARY OF THE INVENTION

It is therefore an object of the present invention to provide a data compression method, a data retrieval method, a data retrieval apparatus, a recording medium, and data packet signal for storing main data in relatively smaller storage area to achieve significantly faster data retrieval than related-art counterpart.

In carrying out the invention and according to one aspect thereof, there is provided a data compression method for efficiently retrieving key data for retrieving main data and compressing a data amount of the key data to be recorded on a recording medium, comprising the steps of: comparing first key data composed of a first number of characters with second key data composed of a second number of characters which is higher than the first number of characters of the first key data; on the basis of a result of the comparison between the first key data and the second key data, detecting the number of matching characters between the first key data and the second key data, deleting a character matching the first key data from the second key data, and generating a data packet having the number of matching characters and a mismatching character obtained by deleting the character matching the first key data from the second key data; and recording the data packet to the recording medium.

In carrying out the invention and according to another aspect thereof, there is provided a data retrieval method for retrieving main data in a data packet configured by the main data and compressed key data configured by the number of duplicate characters between key data associated with the main data and neighborhood key data and a mismatching character obtained by deleting a duplicate character from the key data, on the basis of an inputted search key and the compressed key data, comprising the steps of: retrieving the data packet in which the key data are equal to the mismatching character; detecting a mismatching portion between a mismatch character of the compressed key data in the data packet retrieved in the retrieving step and the search key; and if the mismatching portion is detected between the mismatch character of the compressed key data and the search key, detecting a mismatching portion between a mismatch character of the compressed key data of a data packet adjacent to the data packet and the detected mismatching portion.

In carrying out the invention and according to still another aspect thereof, there is provided a data retrieval apparatus for retrieving main data from a recording medium recording a data packet configured by the main data and compressed key data configured by the number of duplicate characters between key data associated with the main data and neighborhood key data and a mismatching character obtained by deleting a duplicate character from the key data, on the basis of an inputted search key and the compressed key data, the data retrieval apparatus comprising: a recording medium access means for reading the data packet from the recording medium; a retrieval means for retrieving the data packet in which the key data are equal to the mismatching character; a mismatch detecting means for detecting a mismatching character portion between a mismatching character in the compressed key data in a predetermined data packet and an inputted character string for comparison; and a control means for controlling the retrieval means so that the data packet in which the key data are equal to the mismatching character is retrieved, detecting a mismatching portion between the retrieved data packet and the inputted search key by controlling the mismatch detecting means, and, if the mismatching portion is found, detecting, by controlling the mismatch detecting means, a mismatching portion between the detected mismatching portion and a data packet adjacent to the data packet retrieved by the retrieval means read by controlling the recording medium access means.

In carrying out the invention and according to yet another aspect thereof, there is provided a data retrieval apparatus for retrieving main data from a recording medium recording a data packet configured by the main data and compressed key data configured by the number of duplicate characters between key data associated with the main data and neighborhood key data and a mismatching character obtained by deleting a duplicate character from the key data, on the basis of an inputted search key and the compressed key data, the data retrieval apparatus comprising: a recording medium access means for reading the data packet from the recording medium; an operator means for inputting the search key; a display means for displaying the retrieved main data; a compressed key data retrieving means for retrieving the compressed key data from the data packet read from the recording medium; a first comparing means for comparing a mismatching character of the compressed key data with the search key; a holding means for holding, on the basis of a result of the comparison made by the comparing means, the number of mismatching characters between the mismatching character of the compressed key data with the search key; a second comparing means for comparing the number of characters held in the holding means with data indicative of the number of compressed characters; and a control means for controlling the first comparing means so as to compare the search key inputted from the operator means with the number of mismatching characters of the compressed key data retrieved by the compressed key data retrieving means, holding in the holding means the number of matching characters between the search key obtained by comparison by the first comparing means and the compressed key data, comparing the mismatching character of an adjacent data packet with a character string of the search key to be found mismatching by the comparing means, and displaying the main data thus retrieved onto the display means.

In carrying out the invention and according to a different aspect thereof, there is provided a data packet signal having main data and a retrieval character string for retrieving the main data, comprising: a main data signal portion; a mismatching signal portion remaining after compression of a matching character portion between key data for retrieving the main data and key data for another piece of main data; and a compressed character count signal portion indicative of the number of characters of the compressed data.

In carrying out the invention and according to a still different aspect thereof, there is provided a recording medium recording a data packet having main data and compressed data for retrieving the main data, having: the main data; mismatching data remaining after deleting a matching character between retrieval data for retrieving the main data and retrieval data for retrieving main data of a neighboring data packet; and the number of compressed characters indicative of the number of characters deleted as a result of the matching.

### BRIEF DESCRIPTION OF THE DRAWINGS

These and other objects of the invention will be seen by reference to the description, taken in connection with the accompanying drawings, in which:

FIG. 1 is a schematic diagram illustrating data processing in a related-art database retrieval apparatus;

FIG. 2 illustrates one example of a related-art text body database.

FIG. 3 is a flowchart describing related-art comparison processing between search key and selected keyword;

FIG. 4 is a block diagram illustrating the configuration of a database retrieval apparatus practiced as one preferred embodiment of the invention;

FIG. 5 illustrates a packet constituting a text body database 110;

FIG. 6A illustrates a field 1 of the text body database 110;

FIG. 6B illustrates a field 2 of the text body database 110;

FIG. 7A illustrates a packet for header “ap.ple” of the text body database 110;

FIG. 7B illustrates a packet for header “Apple” of the text body database 110;

FIG. 7C illustrates a packet for header “ap.ple. seed” of the text body database 110;

FIG. 7D illustrates a packet for header “applet” of the text body database 110;

FIG. 8 illustrates a result of retrieval to be displayed on a display panel 57;

FIG. 9 illustrates a divided portion of the text body database 110;

FIG. 10 illustrates the configuration of a compressed keyword;

FIGS. 11A and 11B illustrate comparison processing between search key and compressed keyword as compared with comparison processing between search key and uncompressed keyword;

FIG. 12 illustrates a field information table;

FIG. 13 is a flowchart describing retrieval processing of the text body database 110;

FIG. 14 is a flowchart describing comparison processing between search key and selected compressed keyword;

FIG. 15 is a flowchart describing comparison processing between k characters from the beginning of search key and k characters from the beginning of compressed keyword; and

FIG. 16 is a diagram for describing a text body database 101.

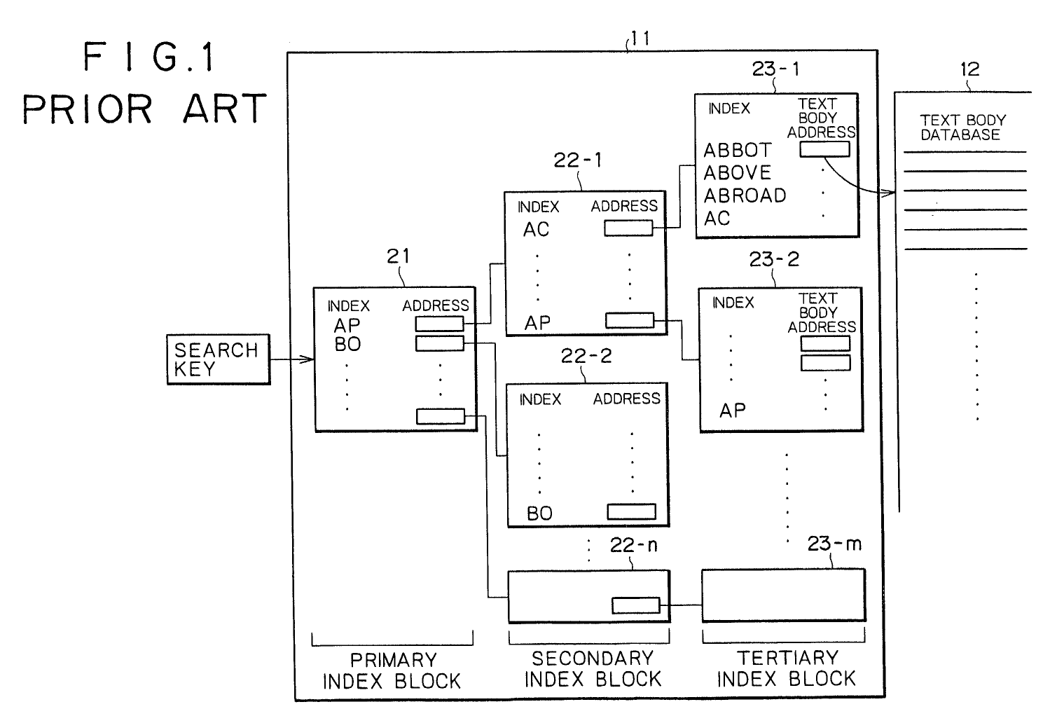

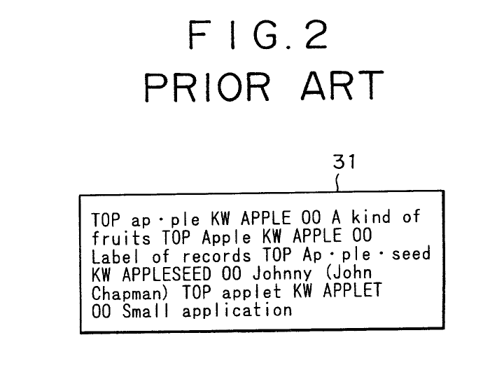

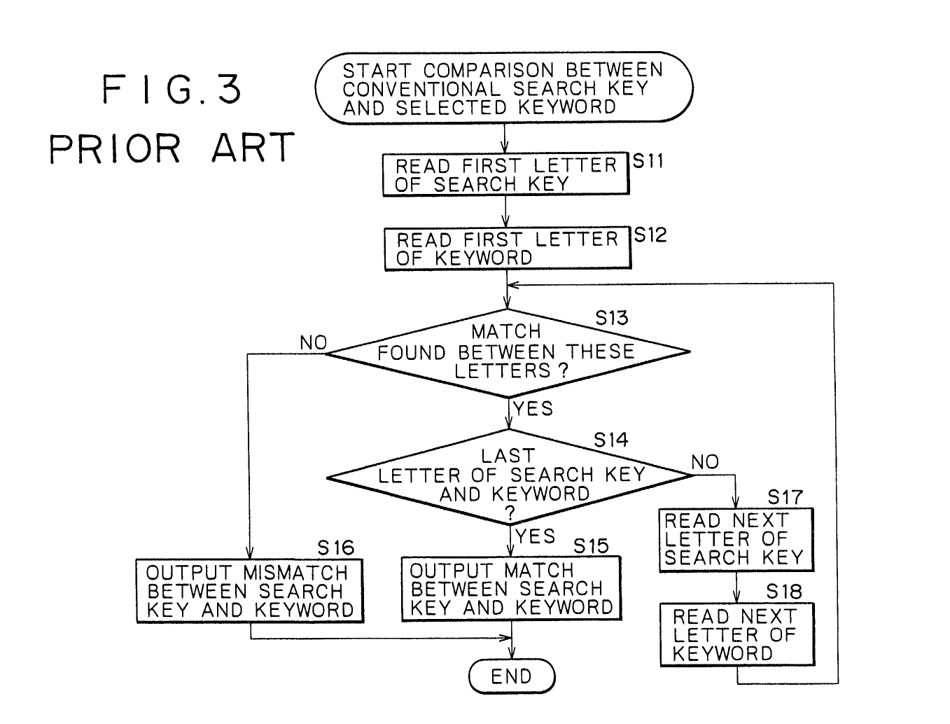

### DETAILED DESCRIPTION OF PREFERRED EMBODIMENTS

This invention will be described in further detail by way of example with reference to the accompanying drawings.

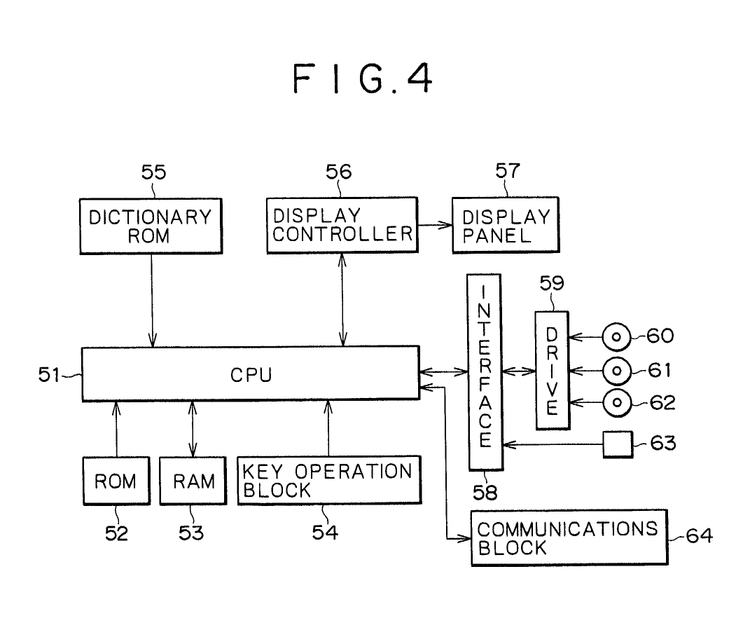

Now, referring to FIG. 4, a CPU (Central Processing Unit) 51, constituted by an MPU (Micro Processing Unit) for example, executes a control program stored in a ROM (Read-Only Memory) 52 to control the database retrieval apparatus in its entirety on the basis of signals inputted from a key operation block 54 and, at the same time, executes processing for retrieving main data that corresponds to an inputted character string.

The ROM 52, constituted by a mask ROM, an EPROM (Erasable Programmable ROM), an EEPROM (Electrically Erasable Programmable ROM), or a flash memory for example, stores the control program to be executed by the CPU 51, basically fixed parameters necessary for the execution of the control program, and font data (data indicative of character shapes) for example.

A RAM (Random Access Memory) 53, constituted by a DRAM (Dynamic RAM) or an SRAM (Static RAM) for example, stores data of which values change as the control program is executed, for example, the number of matching characters (to be described later) which is temporarily stored as a result of retrieval processing. The key operation block 54 has predetermined operator keys and switches and outputs signals generated in correspondence with operations done by the user of the database retrieval apparatus to the CPU 51.

A dictionary ROM 55 serving as a database, constituted by a storage medium such as a mask ROM, an EPROM, an EEPROM, a flash memory, a magnetic disc such as hard disc, a magneto-optical disc, or an optical disc, stores text body data and so on. A display controller 56, under the control of the CPU 51, receives the font data corresponding to predetermined characters indicative of a retrieval result for example from the ROM 52 and displays the received characters on a display panel 57. The display panel 57, constituted by an LCD (Liquid Crystal Display) or the like, displays predetermined characters or images under the control of the display controller 56.

A drive 59 reads data (text body data for example) or programs (including the control program) from a magnetic disc 60, an optical disc 61, or a magneto-optical disc 62 loaded in the drive 59 and supplies the data or programs to the CPU 51 through an interface 58. Under the control of the CPU 51, the interface 58 supplies the data or programs received from the drive 59 to the CPU 51 and, at the same time, reads data such as text body data or programs including the control program from a semiconductor memory 63 loaded in the interface 58 to supply them to the CPU 51.

A communications block 64, constituted by a router, a modem, or a communications circuit corresponding to a predetermined communications scheme, receives predetermined data or programs through wired or wireless communications media such as a local area network, the Internet, and digital satellite broadcasting, not shown, and supplies the received data and programs to the CPU 51.

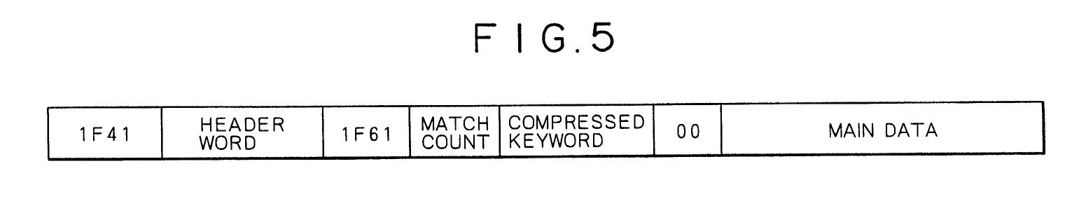

Referring to FIG. 5, there is shown a data format for one piece of main data to be stored in the dictionary ROM 55 as a database. As shown, each piece of main data is packetized into a packet called text body data. The main data are stored in a predetermined order. Each packet begins with a header. In this example, the header, which is fixed in length, is assigned with “1F41”. The header is followed by a header word indicative of a summary of the main data. The header word is variable in length and ends with a header word end code. In this example, the header word end code is “1F61”. The header word end code is followed by a match count. The match count indicates the number of compressed characters in a compressed keyword to be described later. On the basis of the match count, the keyword is decompressed as will be described later. The match count is followed by a compressed keyword. The end of the compressed keyword is identified by “00” of main data identification data indicative of the beginning of the main data. The main data identification data are followed by the main data. The packet for one piece of main data ends at the end of the main data.

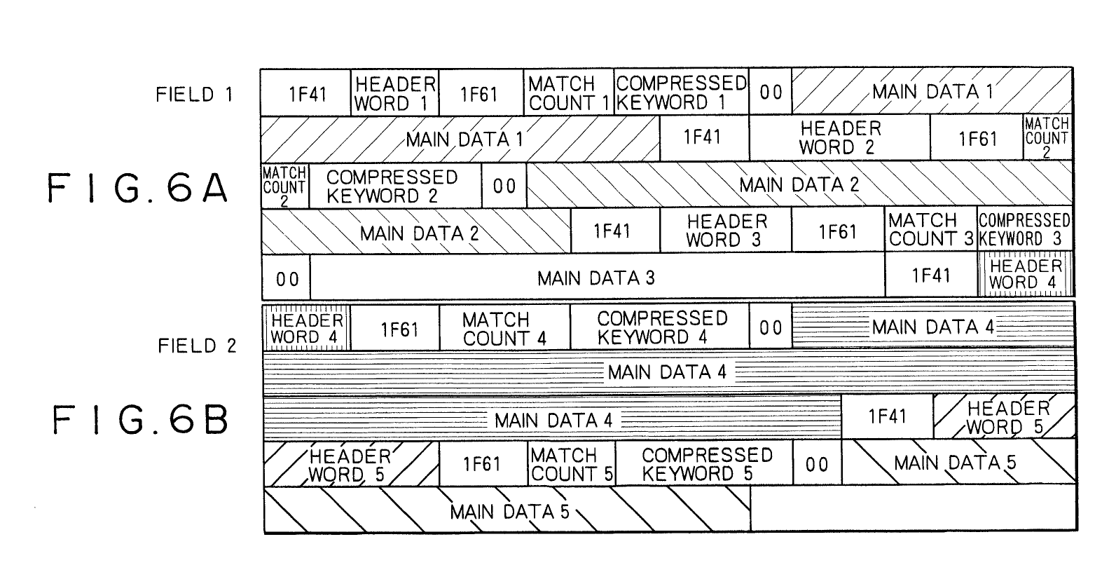

FIGS. 6A and 6B show states in which plural packets, one of which was described with reference to FIG. 5, are stored in the dictionary ROM 55. FIGS. 6A and 6B represent blocks obtained by dividing a storage area in the dictionary ROM 55 by a predetermined size. Each block is referred to as a field. The division of the storage area into fields may be made physically or logically. By whichever manner the division is made, there is no difference in access to the resultant fields. Field 1 and field 2 are stored in the dictionary ROM 55 so that they can be read continuously. Therefore, header word 4 is stored over field 1 and field 2. In a read operation, header word 4 in field 1 and header word 4 in field 2 are linked together. As shown in FIGS. 6A and 6B, in each field, plural packets are stored continuously. Field 1 contains packet 1 for main data 1, packet 2 for main data 2, packet 3 for main data 3, and a part of packet 4 for main data 4. Field 2 contains a remaining part of packet 4, packet 5 for main data 5. As shown in FIG. 5, each packet begins with “1F41” and ends with the main data. Because the packets are stored continuously as shown in FIGS. 6A and 6B, the end of each packet can be easily detected by searching for “1F41”, which is the header of the following packet. For example, for packet 1, detecting “1F41” located immediately before header word 2 can detect the end position of main data 1 and the end point of packet 1.

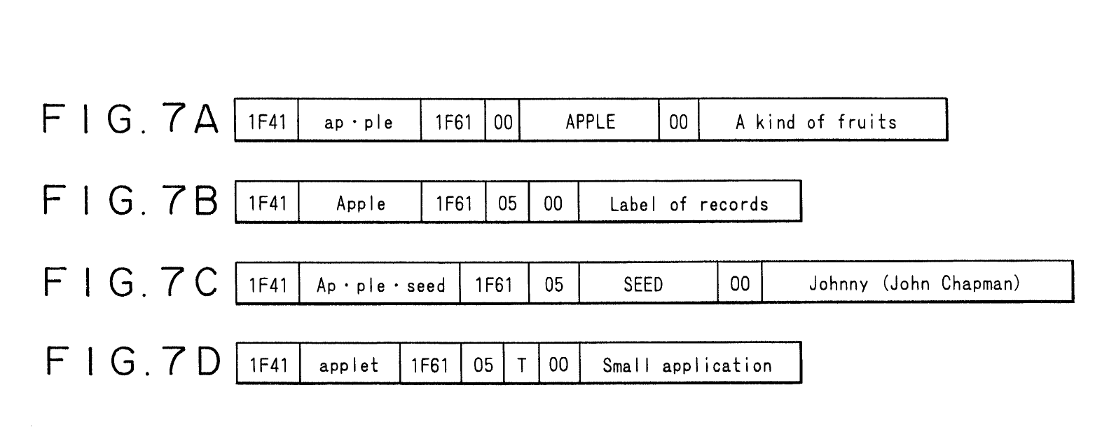

FIGS. 7A, 7B, 7C, and 7D show specific packets by way of example. FIG. 7A shows a packet for data of which keyword is “APPLE”. FIG. 7B shows a packet for data of which keyword is “APPLE”. FIG. 7C shows a packet for data of which keyword is “APPLESEED”. FIG. 7D shows a packet for data of which keyword is “APPLET”.

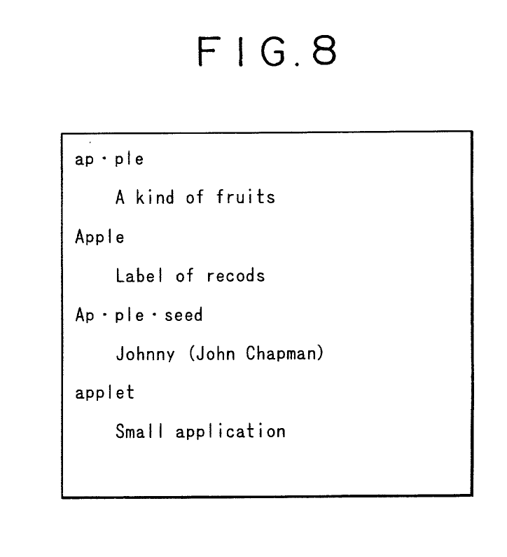

Referring to FIG. 8, there is shown an example of a display on the display panel 57 to be executed by the database retrieval apparatus according to the invention when text body data 110 shown in FIG. 10 are searched for in forward matching search with “APPLE” used as a search key.

As shown in FIG. 8, the identifier having value “1F41”, the identifier having value “1F61”, the identifier having value “00”, and the compressed keyword are not displayed on the display panel 57. The database retrieval apparatus according to the invention displays the retrieved header words to the left side of the display panel 57 and, below them, the corresponding main data in an indented manner.

If there are two or more retrieved header words and text bodies, the database retrieval apparatus according to the invention displays one retrieved text body followed by a next header word on a new line.

To be more specific, header word “ap.ple” is displayed in the upper left on the display panel 57. Main data “A kind of fruits” corresponding to this header word is displayed below it. Header word “Apple” is displayed below main data “A kind of fruits”. Text body “Label of records” corresponding to header word “Apple” is displayed below it.

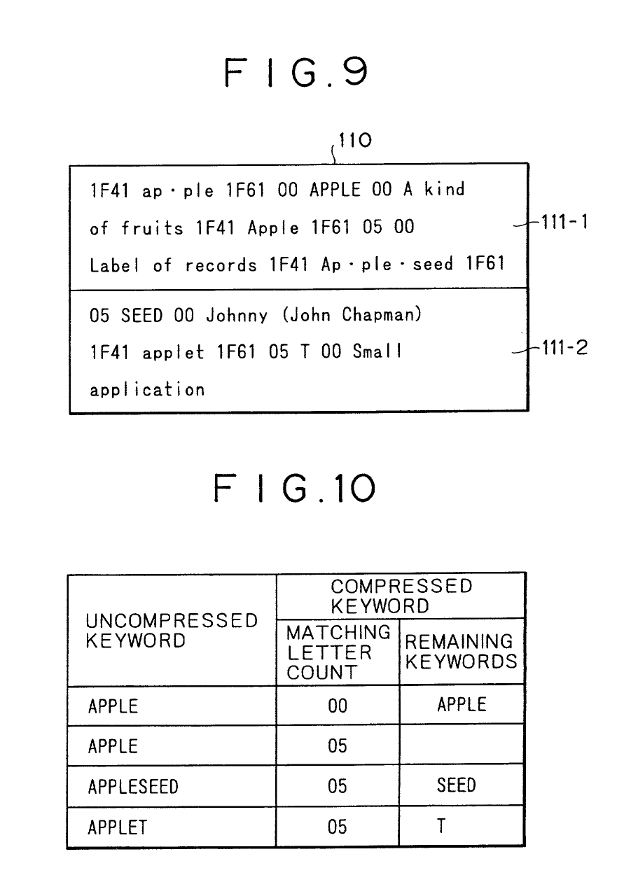

Referring to FIG. 9 again, in data represented by “1F41 Apple 1F61 01 00” in text body data 81, “Apple” between identifiers “1F41” and “1F61” indicates a header word.

“05” between identifiers “1F61” and “00” indicates a compressed keyword for header “Apple”. “Label of records” behind identifier “00” indicates main data for header “Apple” and compressed keyword “05”.

Likewise, in data represented by “1F41 Ap.ple. seed 1F61 05 seed 00 Johnny (John Chapman)” in text body data 110 for example, “Ap.ple seed” between identifiers “1F41” and “1F61” indicates a header word. “05 seed” between identifiers “1F61” and “00” indicates a compressed keyword for header word “Ap.ple.seed”.

“Johnny (John Chapman)” behind identifier “00“indicates main data corresponding to header word “Ap. ple.seed” and compressed keyword “05 seed”.

The text body data 110 are divided into fields 111-1 through 111-2 having predetermined storage areas. In the example shown in FIG. 9, the text body data 110 are divided into two fields 111-1 and 111-2. The text body data 110 may also be divided into more than two fields.

The following describes the configuration of a compressed keyword with reference to FIG. 10. In the figure, the left column shows keywords before compression and the right column shows corresponding compressed keywords.

To be more specific, if the keywords before compressed are arranged in text body data in the order of “APPLE”, “APPLE”, “APPLESEED” and “APPLET”, then, in the compressed text body data 110, the compressed keywords are a compressed keyword of which matching character count is “00” and remaining keyword is “APPLE”, a compressed keyword of which matching character count is “05” and remaining keyword is null, a compressed keyword of which matching character count is “05” and remaining keyword is “SEED”, and a compressed keyword of which matching character count is “05” and remaining keyword is “T”.

Namely, in the compressed text body data 110, keyword “APPLE” before compression is replaced by the keyword of which matching character count is “00” and remaining keyword is “APPLE”, keyword “APPLE” (second from top in the figure) before compression is replaced by the compressed keyword of which matching character count is “05” and remaining keyword is null, and keyword “APPLESEED” before compression is replaced by the compressed keyword of which matching character count is “05” and remaining keyword is “SEED”.

Likewise, in the compressed text body data 110, keyword “APPLET” before compression is replaced by the compressed keyword of which matching character count is “05” and remaining keyword is “T”.

The matching character count of each compressed keyword sets the number of characters of the first character string of an uncompressed keyword corresponding to the preceding compressed keyword, to the number of characters matching the number of characters of the compressed keyword.

The remaining compressed keyword sets the remaining characters resulted from deleting the matching characters from the beginning of the uncompressed keyword.

For example, if uncompressed keyword “APPLE” is followed by uncompressed keyword “APPLE”, these keywords match each other in the first 5 characters. Therefore, “05” is set to the matching character count of the compressed keyword corresponding to the uncompressed keyword “APPLE” (second from top in FIG. 10) and null is set to the remaining keyword because nothing remains by canceling these two uncompressed keywords “APPLE” each other.

Namely, for words having same spelling but different senses, “APPLE” is set as the remaining keyword to the preceding word having same spelling but different senses and the remaining keyword for the following word having same spelling but different senses becomes null.

If uncompressed keyword “APPLESEED” follows uncompressed keyword “APPLE”, the uncompressed keyword “APPLESEED” matches the preceding uncompressed keyword “APPLE” in the first 5 characters, so that “05” is set to the matching character count of the compressed keyword corresponding to the uncompressed keyword “APPLE” and “SEED” resulted from deleting the first 5 characters from “APPLESEED” is set to the remaining keyword.

For example, if uncompressed keyword “APPLESEED” is followed by uncompressed keyword “APPLET”, these keywords match each other in the first 5 characters, so that “05” is set to the matching character count of the compressed keyword corresponding to the uncompressed keyword “APPLET” and “T” resulted from deleting the first 5 characters from “APPLET” is set to the remaining character.

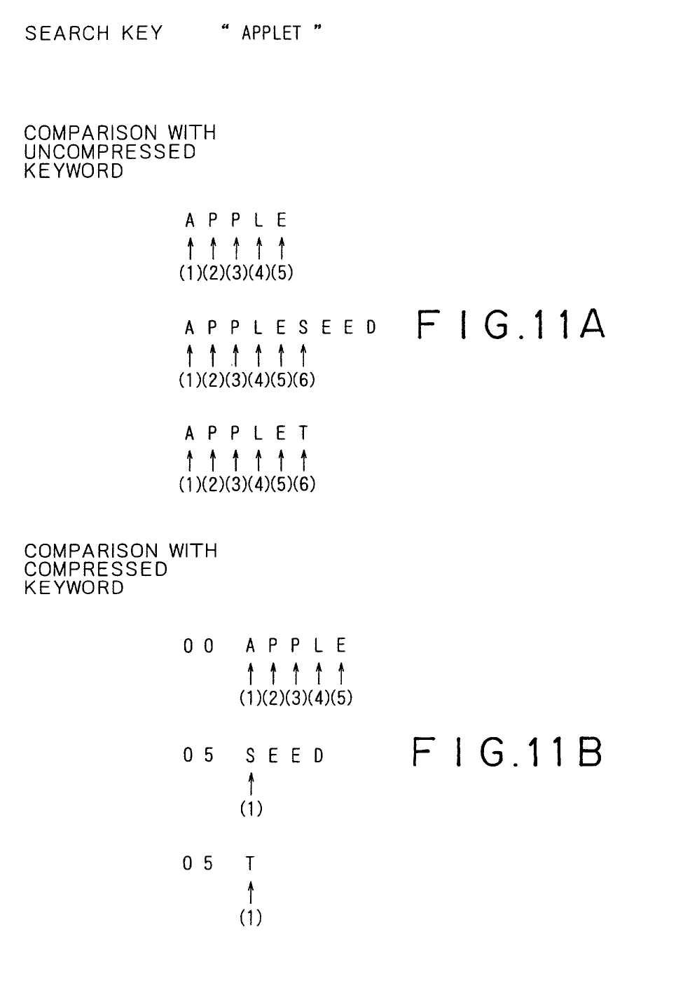

The following describes, with reference to FIGS. 11A and 11B, the processing of comparison between search key and compressed keyword as compared with comparison between search key and uncompressed keyword.

In a retrieval by use of uncompressed keywords shown in FIG. 11A, if keyword “APPLE”, keyword “APPLESEED” and keyword “APPLET” are arranged in this order in text body data and the search key is “APPLET”, then the database retrieval apparatus first compares the search key “APPLET” with the keyword “APPLE”.

The database retrieval apparatus compares the first character “A” of the search key “APPLET” with the first character “A” of the uncompressed keyword “APPLE”. Because both match each other, the database retrieval apparatus then compares the second character “P” of the search key “APPLET” and the second character “P” of the uncompressed keyword “APPLE”.

Because both match each other, the database retrieval apparatus next compares the third character “P” of the search key “APPLESEED” with the third character “P” of the uncompressed keyword “APPLE”. Because both match each other, the database retrieval apparatus next compares the fourth character “L” of the search key with the fourth character “L” of the uncompressed keyword.

Because both match each other, the database retrieval apparatus next compares the fifth character “E” of the search key “APPLET” with the fifth character “E” of the uncompressed keyword “APPLE”. Because both match each other, the database retrieval apparatus next compares the sixth character “T” of the search key “APPLET” with the sixth character of the uncompressed keyword.

However, there is no sixth character in the uncompressed keyword to be compared with the sixth character “T” of the search key, the database retrieval apparatus determines that the search key “APPLET” does not match the uncompressed keyword “APPLE”.

Next, the database retrieval apparatus compares the search key “APPLET” with an uncompressed keyword “APPLESEED”. As above, the database retrieval apparatus compares the search key “APPLET” with the uncompressed keyword “APPLESEED” one by one from the beginnings of these character strings. When the sixth character “T” of the search key “APPLET” is compared with the sixth character “S” of the uncompressed keyword “APPLESEED”, there is no match, so that the database retrieval apparatus determines that the search key “APPLET” does not match the uncompressed keyword “APPLESEED”.

The database retrieval apparatus compares the search key “APPLET” with an uncompressed keyword “APPLET”. The database retrieval apparatus compares the characters of the search key “APPLET” with the characters of the keyword “APPLET” from the beginning one by one. When the database retrieval apparatus compares the sixth character “T” of the search key “APPLET” with the sixth character “T” of the uncompressed keyword “APPLET” and determines that both match each other, then, the database retrieval apparatus determines whether both are the last of the character strings of the search key and the uncompressed keyword. Because both are the last characters, the database retrieval apparatus determines that there is a match between the search key and the uncompressed keyword.

The following describes data retrieval processing based on compressed keywords. If the text body data 110 contains compressed keywords “00 APPLE”, “05 SEED”, and “05 T” in this order and the search key is “APPLET”, then the database retrieval apparatus compares the search key “APPLET” with the compressed key word “00 APPLE”.

Because the matching character count is “00”, the database retrieval apparatus compares the first character “A” of the search key “APPLET” with the first character “A” of the remaining keyword “APPLE” of the compressed keyword. Because both match each other, the database retrieval apparatus then compares the second character “P” of the search key “APPLET” with the second character “P” of the remaining keyword “APPLE”.

Because both match each other, the database retrieval apparatus then compares the third character “P” of the search key with the third character “P” of the remaining keyword “P”. Because both match each other, the database retrieval apparatus then compares the fourth character “L” of the search key “APPLET” with the fourth character “L” of the remaining keyword “APPLE”.

Because both match each other, the database retrieval apparatus then compares the fifth character “E” of the search key “APPLET” with the fifth character “E” of the remaining keyword “APPLE”.

Because both match each other, the database retrieval apparatus then attempts to compare the sixth character “T” of the search key “APPLET” with the sixth character of the remaining keyword “APPLE”. But there is no sixth character in the remaining keyword, the database retrieval apparatus determines that there is no match between the search key “APPLET” and the compressed key word “00 APPLE”.

Consequently, the database retrieval apparatus stores a match between the search key “APPLET” and the compressed keyword “00 APPLE” in the first 5 characters.

Next, the database retrieval apparatus compares the search key “APPLET” with the compressed keyword “05 SEED”. Because the database retrieval apparatus stores the match found in the last comparison between the search key “APPLET” and the compressed keyword “00 APPLE” in the first 5 characters and the matching character count of the compressed keyword “05 SEED” is ” 05”, the database retrieval apparatus compares the sixth character “T” of the search key “APPLET” with the first character “S” of the remaining keyword “SEED” of the compressed keyword.

Because both do not match each other, the database retrieval apparatus determines that there is no match between the search key “APPLET” and the compressed keyword “05 SEED”.

Consequently, the database retrieval apparatus stores a match between the search key “APPLET” and the compressed keyword “05 SEED” in the first 5 characters.

Next, the database retrieval apparatus compares the search key “APPLE” with a compressed keyword “05 T”. Because the database retrieval apparatus stores the match between the search key “APPLET” and the compressed keyword “05 SEED” in the first 5 characters and the matching character count of the compressed keyword “05 T” is “05”, the database retrieval apparatus compares the sixth character “T” of the search key “APPLET” with the first character “T” of the compressed keyword “T”.

Because both match each other, the database retrieval apparatus determines whether the sixth character “T” of the search key “APPLET” and the first character “T” of the remaining keyword “T” of the compressed keyword are both the last characters. Because these characters are both the last characters, the database retrieval apparatus determines that there is a match between the search key “APPLE” and the compressed keyword “05 T”.

Thus, by use of compressed keywords, the database retrieval apparatus can retrieve a word or a sentence corresponding to a keyword before being compressed. Retrieval of the text body data 110 by use of compressed keywords sometimes does not compare the same character strings included in plural keywords, thereby allowing the database retrieval apparatus to decrease the number of times comparison is made between character strings as compared with the comparison based on uncompressed keywords.

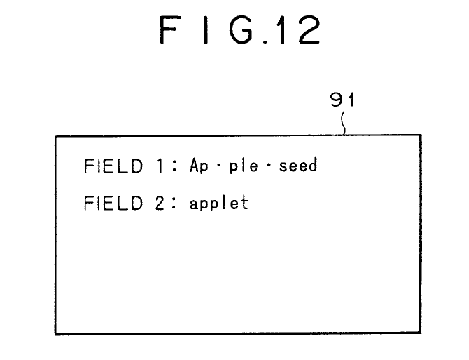

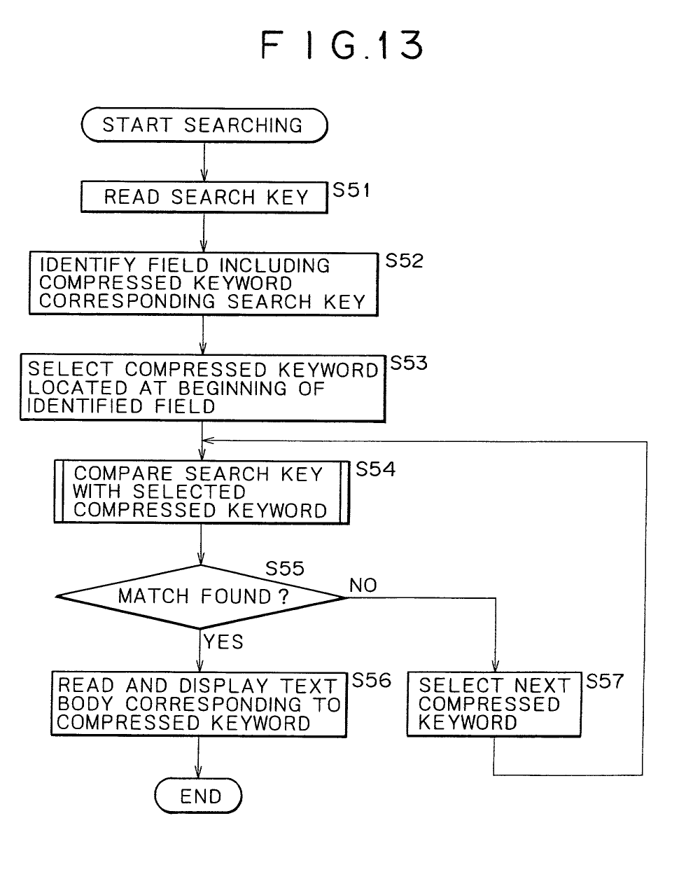

The following describes a field information table 91 stored in the dictionary ROM 55 with reference to FIG. 12. A field information table 91 stores data indicative of the last header words stored in the fields 111-1 and 111-2 of the text body data 110. For example, in the example shown in FIG. 12, the field information table 91 stores data indicating that the last header word stored in the field 111-1 is “Ap.ple seed” (the beginning character of the header word is stored in the field 111-1) and the last header word stored in the field 111-2 is “applet”.

Hereafter, the fields 111-1 and 111-2 are generically referred to as a field 111 unless especially noted.

The following describes retrieval processing to be executed on the text body data 110 by the CPU 51 as instructed by the control program stored in the ROM 52, with reference to the flowchart shown in FIG. 13. First, in step S51, the control program, on the basis of a signal supplied from the key operation block 54, reads a search key. In step S52, the control program refers to the field information table stored in the dictionary ROM 55 to identify the field 111 that contains a compressed keyword corresponding to the search key.

Because the field 111 having a predetermined storage area is identified to search for a compressed keyword stored in the identified field 111, the database retrieval apparatus can reduce the number of compressed keywords to be compared as compared with a method in which the text body data 110 are searched in its entirety.

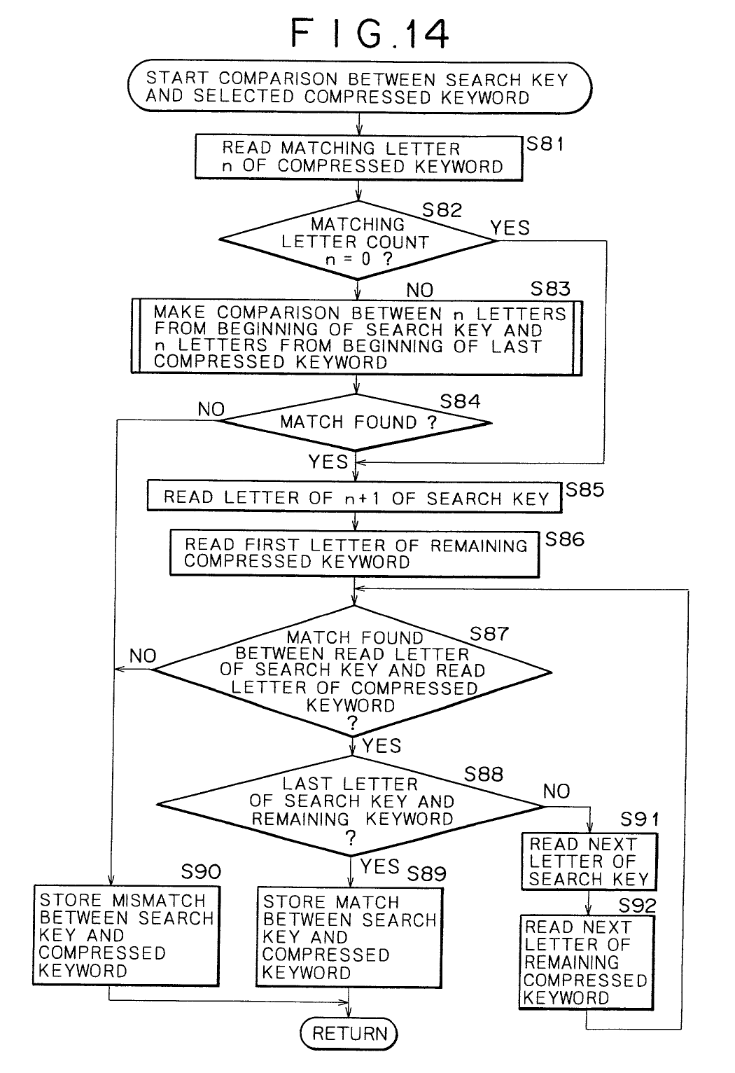

In step S53, the control program selects the compressed keyword located at the beginning of the field 111 identified in step S52. In step S54, the control program executes comparison between the search key and the selected compressed keyword. The processing of step S54 will be detailed with reference to the flowchart shown in FIG. 14.

In step S55, the control program, on the basis of the result of the processing in step S54, determines whether there is a match between the search key and the selected compressed keyword. If the decision is yes, then, in step S56, the control reads the text body corresponding to the compressed keyword from the text body data 110 stored in the dictionary ROM 55 and makes the display controller 56 show the retrieved text body onto the display panel 57, upon which the processing comes to an end.

If the decision is no in step S55, then the control program selects a next compressed keyword from the text body data 110 stored in the dictionary ROM 55 in step S57, returning to step S54 to repeat the above-mentioned comparison processing.

Thus, the database retrieval apparatus retrieves a specified text body on the basis of compressed keywords stored in the text body data 110.

The following describes, with reference to the flowchart shown in FIG. 14, the comparison processing, corresponding to step S54, between search key and selected compressed keyword to be executed by the CPU 51 as instructed by the control program stored in the ROM 52. In step S81, the control program reads matching character count n of a selected compressed keywords from the dictionary ROM 55.

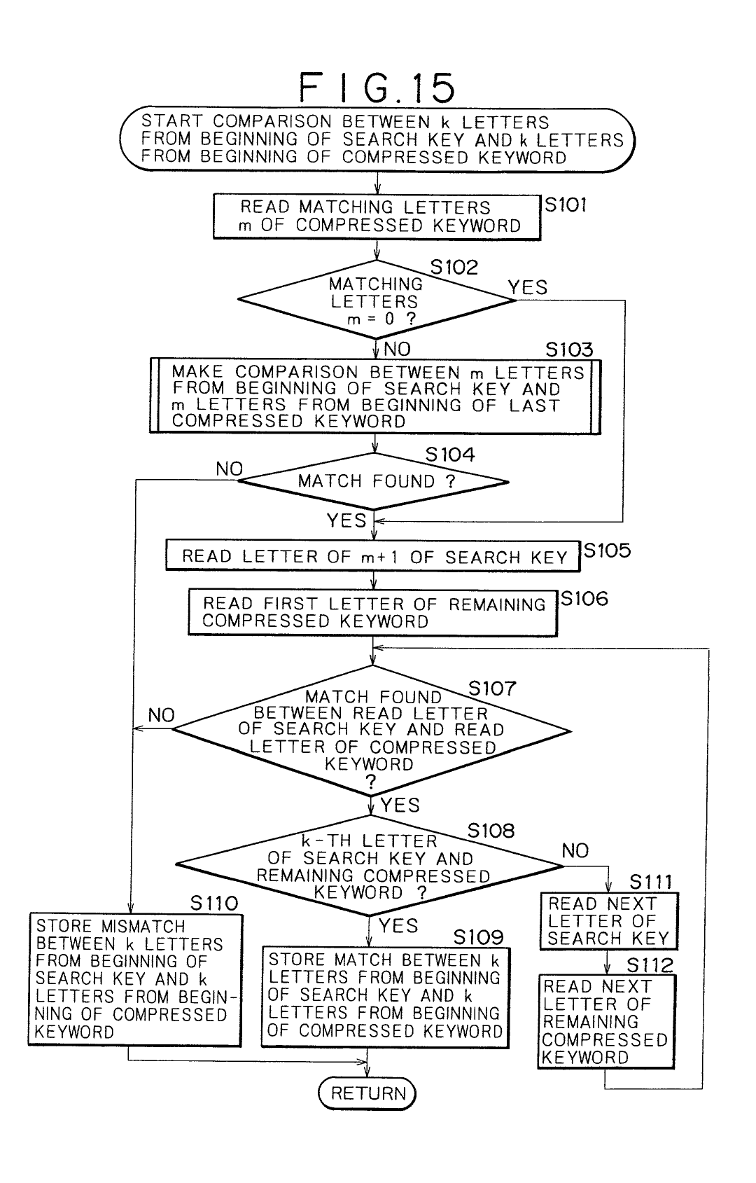

In step S82, the control program determines whether the matching character count n of the compressed keyword is 0 or not. If the matching character count n is not 0, then in step S83, the control program executes the processing of comparison between n characters from the beginning of the search key and n characters from the beginning of the immediately preceding compressed keyword. The processing of step S83 will be detailed with reference to the flowchart shown in FIG. 15.

If the matching character count of the search key and the immediately preceding compressed keyword is stored and a match is found between n characters from the beginning of the search key and n characters from the beginning of the immediately preceding compressed keyword in step S90 and step S110 to be described later, then step S83 is skipped.

In step S84, the control program, on the basis of the result of the processing in step S83, determines whether there is a match between n characters from the beginning of the search key and n characters from the beginning of the immediately preceding compressed keyword. If a match is found, then the control program reads the n+1 character of the search key in step S85. In step S86, the control program reads the first character of the remaining keyword of the compressed keyword from the text body data 110 stored in the dictionary ROM 55.

In step S87, the control program determines whether there is a match between the read character of the search key and the read character of the remaining keyword. If a match is found, then the control program determines whether the read characters are the last characters of the search key and the remaining keyword in step S88.

If the read characters are found the last characters in step S88, then the control program stores the match between the search key and the compressed keyword in step S89, upon which the processing comes to an end.

If no match is found in step S84 between n characters from the beginning of the search key and n characters from the beginning of the immediately preceding compressed keyword and if no match is found in step S87 between the read character of the search key and the read character of the remaining keyword, then in step S90 the control program stores a mismatch between the search key and the compressed keyword. Then, the control program stores the number of matching characters between the search key and the compressed keyword, upon which the processing comes to an end.

If the read characters are found not the last characters in step S88, then the control program reads the next character of the search key in step S91. In step S92, the control program reads the next character of the remaining keyword of the compressed keyword from the text body data 110 stored in the dictionary ROM 55 and proceeds to step S87 to repeat the character comparison processing.

If the matching character count n of the compressed keyword is found 0 in step S82, no processing for the matching character count is required, so that the control program proceeds to step S85 to execute character comparison.

Thus, the database retrieval apparatus executes comparison between search key and selected compressed keyword and stores the match or mismatch between them.

The following describes, with reference to the flowchart shown in FIG. 15, the comparison processing for step S83 to be executed between k characters from the beginning of a search key and k characters from the beginning of a compressed keyword by the CPU 51 on the basis of the control program stored in the ROM 52. First, in step S101, the control program reads the matching character count m of the compressed keyword from the dictionary ROM 55.

In step S102, the control program determines whether the matching character count m of the compressed keyword is 0 or not. If the decision is no, then the control program proceeds to step S103 and executes comparison between the m characters from the beginning of the search key and the m characters from the beginning of the immediately preceding compressed keyword. Namely, the control program recursively executes the comparison between k characters from the beginning of the search key and k characters from the beginning of the compressed keyword.

If the matching character count of the search key and the immediately preceding compressed keyword is stored and a match is found between m characters from the beginning of the search key and m characters from the beginning of the immediately preceding compressed keyword in step S90 and step S110, then step S103 is skipped.

In step S104, the control program determines, on the basis of the result of the processing executed in step S103, whether there is a match between the m characters from the beginning of the search key and the m characters from the beginning of the immediately preceding compressed keyword. If a match is found, the control program proceeds to step S105 and reads the m+1 character of the search key. In step S106, the control program reads the first character of the remaining keyword of the compressed keyword from the text body data 110 stored in the dictionary ROM 55.

In step S107, the control program determines whether there is a match found between the read character of the search key and the character of the remaining keyword. If a match is found, the control program proceeds to step S108 to determine whether the read characters are the k-th characters of the search key and the compressed keyword.

If the read characters are found the k-th characters of the search key and the compressed keyword in step S108, then the control program proceeds to step S109 to store the match between the k characters from the beginning of the search key and the k characters from the beginning of the compressed keyword, upon which the processing comes to an end.

If no match is found between the m characters from the beginning of the search key and the m characters from the beginning of the immediately preceding compressed keyword in step S104 and no match is found between the read character of the search key and the character of the remaining keyword in step S107, then the control program proceeds to step S110 to store the mismatch between the k characters from the beginning of the search key and the k characters from the beginning of the compressed keyword. Then, the control program stores the number of matching characters between the search key and the compressed keyword, upon which the processing comes to an end.

If the read characters are found not the k-th characters of the search key and the compressed keyword in step S108, then the control program proceeds to step S111 to read the next character of the search key. In step S112, the control program reads the next character of the remaining keyword of the compressed keyword from the text body data 110 stored in the dictionary ROM 55 and proceeds to step S107 to repeat the character comparison processing.

If the matching character count m of the compressed keyword is found 0 in step S102, the processing for the matching character count is not required, so that the control program proceeds to step S105 to execute the character comparison processing.

Thus, the database retrieval apparatus executes comparison between the k characters from the beginning of the search key and the k characters from the beginning of compressed keyword and stores a result indicative of whether there is a match between these k characters.

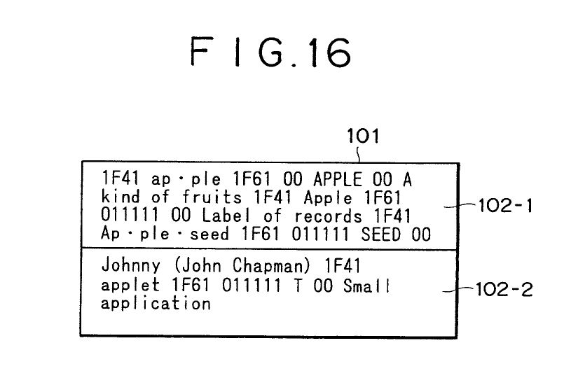

Referring to FIG. 16, there is shown a diagram for describing another piece of text body data 101 stored in the dictionary ROM 55. The matching character count of a compressed keyword in the text body data 101 is set to “00” if an uncompressed keyword is followed by another uncompressed keyword and the first character strings of these uncompressed keywords do not match each other. The matching character count of the compressed keyword is set to “1” after “0” if the number of matching characters in these character strings of the uncompressed keywords is 1 or more.

For example, if an uncompressed keyword “APPLE” is followed by an uncompressed keyword “APPLESEED”, the latter and the former match each other in the first 5 characters, so that “011111” is set to the matching character count of a compressed keyword corresponding to the uncompressed keyword “APPLESEED” and “SEED” resulted from deleting the first 5 characters of the “APPLESEED” is set to the remaining keyword.

The text body data 101 are divided into fields 102-1 through 102-2 each having a predetermined storage area. In the example shown in FIG. 16, the text body data 101 are divided into two fields 102-1 and 102-2. However, the text body data 101 may be divided into more than two.

Thus, the retrieval of the text body data 110 or 101 requires no index. In addition, compression keywords consisting of less characters than the conventional counterpart are stored in the text body data 110 or 101. These consequently reduce the size of the storage area for storing the text body data 110 or 101. For example, compressed keywords of about 1.5 megabytes including predetermined identifiers are stored in text body data which store a text body of 60,000 to 70,000 words.

Further, the retrieval processing based on compressed keywords is faster than the related-art counterpart because of a smaller number of characters to be compared.

In the above-mentioned embodiment, the dictionary ROM 55 is used to store the text body data 110. It will be apparent to those skilled in the art that the text body data 110 may be stored on the magnetic disc 60, the optical disc 61, the magneto-optical disc 62, or the semiconductor memory 63. Namely, the information storage medium associated with the present invention is constituted by the dictionary ROM 55, the magnetic disc 60, the optical disc 61, the magneto-optical disc, or the semiconductor memory 63 for example.

In the above-mentioned embodiment, the dictionary ROM 55 stores the text body data 110 in advance. It will be apparent to those skilled in the art that the dictionary ROM 55 may be constituted by an EEPROM for example to store the text body data 110 via the communications block 64.

The above-mentioned sequence of processing operations may be executed by hardware as well as software. For the execution by software, a computer is used in which the programs constituting this software are stored in a dedicated hardware device; otherwise a general-purpose personal computer for example is used in which these programs are installed from a program storage medium.

A program storage medium for storing computer-readable and executable programs may be a package medium constituted by the magnetic disc 60 (including floppy disc), the optical disc 61 (including CD-ROM (Compact Disc-Read Only Memory) and DVD (Digital Versatile Disc)), the magneto-optical disc 62 (including MD (Mini-Disc)), or the semiconductor memory 63, the ROM 52 on which the programs are stored temporarily or permanently, or a hard disc, not shown. Programs are stored in the program storage medium from wired or wireless communications media such as a local area network, the Internet, and digital satellite broadcasting via the communications block 64 constituted by a router or modem as required.

It should be noted that the steps describing the programs to be stored in the program storage medium are not only executed in a time-dependent manner in the order described, but also in parallel or in a discrete manner.

While the preferred embodiments of the present invention have been described using specific terms, such description is for illustrative purposes only, and it is to be understood that changes and variations may be made without departing from the spirit or scope of the appended claims.

What is claimed is:

1. A data compression method for efficiently retrieving key data for retrieving main data and compressing a data amount of said key data to be recorded on a recording medium, comprising the steps of:
comparing first key data composed of a first number of characters with second key data composed of a second number of characters which is greater than said first number of characters of said first key data;
on the basis of a result of the comparison between said first key data and said second key data, detecting the number of matching characters between said first key data and said second key data, deleting a character matching said first key data from said second key data, and generating a data packet having said number of matching characters and a mismatching character obtained by deleting said character matching said first key data from said second key data; and
recording said data packet to said recording medium.

2. The data compression method according to claim 1, wherein said first key data and said second key data are located in the neighborhood of each other in a predetermined arrangement rule.

3. The data compression method according to claim 1, wherein said recording medium has a plurality of storage area each having a predetermined storage size, said method further comprising the steps of:
selecting one piece of key data from at least one of said data packets to be recorded on each of said plurality of recording areas on said recording medium; and
recording said key data selected for each of said plurality of recording areas on said recording medium by relating said key data to each of said plurality of recording areas.

4. A data retrieval method for retrieving main data in a data packet configured by said main data and compressed key data configured by the number of duplicate characters between key data associated with said main data and neighborhood key data and a mismatching character obtained by deleting a duplicate character from said key data, on the basis of an inputted search key and said compressed key data, comprising the steps of:
retrieving said data packet in which said key data are equal to said mismatching character;
detecting a mismatching portion between a mismatch character of said compressed key data in said data packet retrieved in the retrieving step and said search key; and
if said mismatching portion is detected between said mismatch character of said compressed key data and said search key, detecting a mismatching portion between a mismatch character of said compressed key data of a data packet adjacent to said data packet and said detected mismatching portion.

5. The data retrieval method according to claim 4, wherein said recording medium having a plurality of storage areas each having a predetermined storage size and a plurality of storage area search keys for searching said plurality of storage areas, the step of retrieving said data packet in which said key data are equal to said mismatching character further comprising the step of:
searching forehand the storage area in the neighborhood of the storage area in which the retrieved data packet is stored, on the basis of said search key and said storage area search key.

6. The data retrieval method according to claim 4, wherein the data packets recorded on said recording medium are arranged in accordance with a predetermined arrangement rule.

7. A data retrieval apparatus for retrieving main data from a recording medium recording a data packet configured by said main data and compressed key data configured by the number of duplicate characters between key data associated with said main data and neighborhood key data and a mismatching character obtained by deleting a duplicate character from said key data, on the basis of an inputted search key and said compressed key data, said data retrieval apparatus comprising:
recording medium access means for reading said data packet from said recording medium;
retrieval means for retrieving said data packet in which said key data are equal to said mismatching character;
mismatch detecting means for detecting a mismatching character portion between a mismatching character in said compressed key data in a predetermined data packet and an inputted character string for comparison; and
control means for controlling said retrieval means so that said data packet in which said key data are equal to said mismatching character is retrieved, detecting a mismatching portion between the retrieved data packet and said inputted search key by controlling said mismatch detecting means, and, if said mismatching portion is found, detecting, by controlling said mismatch detecting means, a mismatching portion between the detected mismatching portion and a data packet adjacent to the data packet retrieved by said retrieval means read by controlling said recording medium access means.

8. The data retrieval apparatus according to claim 7, further comprising display means for displaying main data contained in said data packet retrieved by said search key under the control of said control means.

9. The data retrieval apparatus according to claim 7, further comprising input means for inputting said search key, said controls means retrieves said data packet on the basis of said search key inputted from said input means.

10. The data retrieval apparatus according to claim 7, wherein said data packet further having sub data associated with said main data, said data retrieval apparatus displaying said sub data on said display means before displaying said retrieved main data.

11. The data retrieval apparatus according to claim 7, wherein said recording medium has a plurality of packet recording areas each having a predetermined recording size for recording at least one of said data packets and an identification data recording area recording identification data for identifying at least one of said data packets recorded in said plurality of packet recording areas, said identification data being recorded in relation to each of said plurality of packet recording areas,
said data retrieval apparatus further comprising identification data access means for reading said identification data from said identification data recording area, and
said control means controlling said identification data access means on the basis of said inputted search key to start a retrieval from the packet recording area in the neighborhood of the packet recording area in which the data packet to be retrieved is recorded.

12. A data retrieval apparatus for retrieving main data from a recording medium recording a data packet configured by said main data and compressed key data configured by the number of duplicate characters between key data associated with said main data and neighborhood key data and a mismatching character obtained by deleting a duplicate character from said key data, on the basis of an inputted search key and said compressed key data, said data retrieval apparatus comprising:
recording medium access means for reading said data packet from said recording medium;
operator means for inputting said search key;
display means for displaying said retrieved main data;
compressed key data retrieving means for retrieving said compressed key data from said data packet read from said recording medium;
first comparing means for comparing a mismatching character of said compressed key data with said search key;
holding means for holding, on the basis of a result of the comparison made by said comparing means, the number of mismatching characters between the mismatching character of said compressed key data with said search key;
second comparing means for comparing the number of characters held in said holding means with data indicative of the number of compressed characters; and
control means for controlling said first comparing means so as to compare said search key inputted from said operator means with the number of mismatching characters of the compressed key data retrieved by said compressed key data retrieving means, holding in said holding means the number of matching characters between said search key obtained by comparison by said first comparing means and said compressed key data, comparing said mismatching character of an adjacent data packet with a character string of said search key to be found mismatching by said comparing means, and displaying said main data thus retrieved onto said display means.

13. A data packet signal having main data and a retrieval character string for retrieving said main data, comprising:
a main data signal portion;
a mismatching signal portion remaining after compression of a matching character portion between key data for retrieving said main data and key data for another piece of main data; and
a compressed character count signal portion indicative of the number of characters of the compressed data.

14. The data packet signal according to claim 13, further comprising a header word portion indicative of a content of said main data.

15. The data packet signal according to claim 13, wherein said mismatching signal portion is omitted by the compression when said key data for retrieving said main data are equal to said key data of said another main data.

16. The data packet signal according to claim 13, further comprising:
a header signal indicative of the start of said data packet signal;
a header word end signal indicative of the end of said header word signal; and
a main data start signal indicative of the start of said main data.

17. A recording medium recording a data packet having main data and compressed data for retrieving said main data, said data packet comprising:
said main data;
mismatching data remaining after deleting a matching character between retrieval data for retrieving said main data and retrieval data for retrieving main data of a neighboring data packet; and
the number of compressed characters indicative of the number of characters deleted as a result of the matching.

18. The recording medium according to claim 17, wherein the neighboring retrieval data for compression are data packet located before said data packet arranged in accordance with a predetermined arrangement rule.

19. The recording medium according to claim 17, wherein said data packet further having a header word for identifying said main data.

20. The recording medium according to claim 17, further having a block key data recording area for recording block key data for retrieving a block in which one or more of said data packets are put together.
